(19) United States
(12) Patent Application Publication
(10) Pub. No.: US 2024/0002201 A1
(43) Pub. Date: Jan. 4, 2024

(54) SHOCK ABSORPTION PEDAL WITH ADJUSTABLE RESISTANCE

(71) Applicant: BYD COMPANY LIMITED, Shenzhen (CN)

(72) Inventors: Dongliang XIAO, Shenzhen (CN); Longwen LU, Shenzhen (CN)

(21) Appl. No.: 18/470,033

(22) Filed: Sep. 19, 2023

Related U.S. Application Data
(63) Continuation of application No. PCT/CN2022/084076, filed on Mar. 30, 2022.

(30) Foreign Application Priority Data
Jun. 30, 2021 (CN) 202121475372.1

(51) Int. Cl. B66F 9/075; F16F 15/04

(52) U.S. Cl. CPC B66F 9/0759; F16F 15/04

(57) ABSTRACT

A shock absorption pedal with adjustable resistance includes: a fixed guide rail, fixedly connected to a vehicle body; a sliding frame, arranged in a groove of the fixed guide rail, and movable vertically along the fixed guide rail; and a support plate, fixedly connected to the sliding frame. A displacement regulating mechanism is arranged on the fixed guide rail. One end of the displacement regulating mechanism is arranged outside the groove of the fixed guide rail, and another end of the displacement regulating mechanism is connected to one end of a shock absorption spring. Another end of the shock absorption spring is fixedly connected to the sliding frame. A position of the sliding frame is regulable by the displacement regulating mechanism, to adjust a length of the shock absorption spring.

### CROSS-REFERENCE TO RELATED APPLICATIONS

The present application is a continuation application of PCT application No. PCT/CN2022/084076 filed on Mar. 30, 2022, which claims priority to Chinese Patent Application No. 202121475372.1, filed on Jun. 30, 2021 and entitled “SHOCK ABSORPTION PEDAL WITH ADJUSTABLE RESISTANCE”, the entire content of all of which is incorporated herein by reference.

### FIELD

The present disclosure relates to the field of shock absorption devices, and more specifically, to a shock absorption pedal with adjustable resistance.

### BACKGROUND

Industrial vehicles refer to power-driven motor vehicles used for handling, pushing, towing, lifting, stacking, or piling up various goods. Common industrial vehicles are forklifts, side forklifts, towing vehicles, handling vehicles, forklift trucks and so on. The industrial vehicle often includes a pedal, and an operating worker stands on the pedal to manipulate the vehicle. Since the industrial vehicle often bumps in the operation process, a shock absorption mechanism is required to increase the comfort of a user.

### SUMMARY

An objective of the present disclosure is to provide a shock absorption pedal with adjustable resistance, intending to overcome the problem that the process of regulating resistance of the shock absorption spring is cumbersome in the related art and/or other problems. The shock absorption pedal with adjustable resistance has advantages that the resistance of the shock absorption spring can be easily regulated, so that the shock absorption pedal has a good shock absorption effect under different loads.

In order to achieve the above objective, the present disclosure provides a shock absorption pedal with adjustable resistance, including a fixed guide rail, fixed connected to a vehicle body; a sliding frame, arranged in a groove of the fixed guide rail, and movable vertically along the fixed guide rail; and a support plate, fixedly connected to the sliding frame.

A displacement regulating mechanism is arranged on the fixed guide rail. One end of the displacement regulating mechanism is arranged outside the groove of the fixed guide rail, and another end of the displacement regulating mechanism is connected to one end of a shock absorption spring. Another end of the shock absorption spring is fixedly connected to the sliding frame. A position of the sliding frame is regulable by the displacement regulating mechanism, to adjust a length of the shock absorption spring.

Through the disclosed technical solution, since one end of the shock absorption spring of the present disclosure is connected to the displacement regulating mechanism, and another end of the shock absorption spring is fixed onto the sliding frame, the length of the shock absorption spring can be regulated by the displacement regulating mechanism, thereby regulating the resistance of the shock absorption spring. Moreover, since a first end of the displacement regulating mechanism is arranged outside the fixed guide rail, this device does not need to be dismantled in the regulating process, which is very convenient. Further, the guard plate with the through hole is arranged, and the specific state and position of the shock absorption spring can be observed, so that the regulating process is more intuitive. Furthermore, the length can be directly adjusted to an appropriate level by a preset scale according to an actual load. Further, the sliding frame and fixed guide rail are connected by the roller, thereby reducing frictional resistance, so that the better shock absorption effect is better. Furthermore, left and right side surfaces of the sliding frame are connected to the fixed guide rail by the rollers, so that the lateral displacement of the sliding frame can be limited, and the structure of the pedal is more stable. Further, a rebound speed is controlled by the damper to further enhance the shock absorption effect. Further, by arranging the shock absorption pad, the action of vertical limiting is achieved on the support plate. Besides, hard collision when the shock amplitude is too large is avoided, thereby enhancing reliability.

### BRIEF DESCRIPTION OF THE DRAWINGS

FIG. 1 is a front structural view of a shock absorption pedal in the related art;

FIG. 2 is a schematic structural diagram of a shock absorption pedal in the related art; and

FIG. 3 is an exploded structural view of a shock absorption pedal with adjustable resistance according to the present disclosure.

### DETAILED DESCRIPTION

The following detailed description will illustrate the general principles of the invention, examples of which are additionally illustrated in the accompanying drawings. In the drawings, like reference numbers indicate identical or functionally similar elements.

In the present disclosure, without stated to the contrary, directional words such as “up, down, left, and right” are generally up, down, left, and right with reference to the drawings. “Inside and outside” mean inside and outside relative to a contour of each component itself. “Far and near” refers to far and near relative to a component.

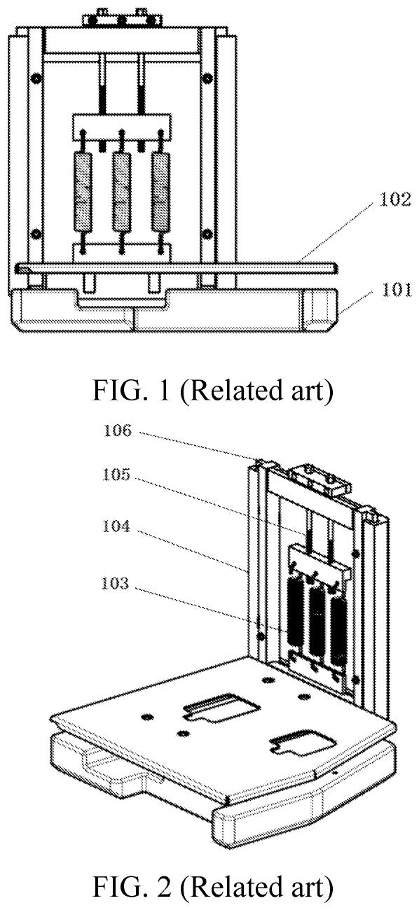

An shock absorption pedal of related art is shown in FIG. 1 to FIG. 2, and includes a support base 101 and a driver pedal 102. The support base 101 is equipped with a pair of guide rails 104 perpendicular thereto. A sliding frame 106 fitting with the guide rail is arranged in the guide rail 104. A bottom of the sliding frame 106 is connected to the driver pedal 102. The driver pedal 102 can move vertically along the guide rail 104 with the sliding frames 106. Tops of the two guide rails 104 are connected by a crossbeam. A middle of the crossbeam is connected to shock absorption springs 103 by two regulating screws 105. One end of the shock absorption spring 103 away from the crossbeam is connected onto the sliding frame 106. When shock occurs, relative displacement occurs between the driver pedal 102 and the guide rails 104, and the shock absorption spring 103 will produce a force to restore the driver pedal 102 to its original position, thereby achieving the shock absorption effect.

However, due to limited workspace of the shock absorption spring 103, when drivers of different weights use a same shock absorption pedal, resistance of the spring is often not suitable. For example, when a heavier driver uses the pedal, a rebound force of the pedal is not enough; or when a lighter driver uses the pedal, the shock absorption spring 103 has excessive resistance and a shock absorption effect is not significant.

Therefore, in order to achieve a better shock absorption effect, it is necessary to adjust the resistance generated by the spring according to load of the shock absorption pedal during use. A common way includes adjusting the resistance by regulating a length of the spring. The spring needs to be removed from the existing shock absorption pedal before regulating the regulating screws 105, to adjust the length of the spring. However, the regulating process is too cumbersome and an operator is required to have a relatively high level of proficiency. If the spring resistance cannot be directly adjusted to a satisfactory level, it is necessary to carry out multiple disassembly and assembly, which is time-consuming and labor-intensive.

Therefore, for those skilled in the art, it is desired to regulate the resistance of the shock absorption spring to enable the shock absorption pedal to have a good shock absorption effect under different loads is an urgent problem.

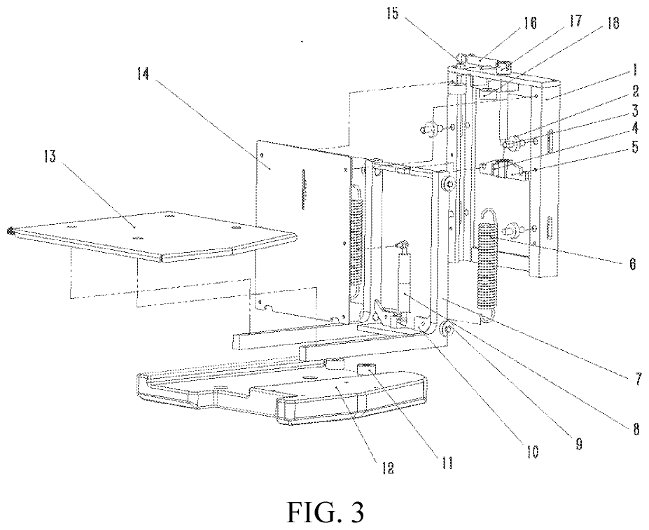

As shown in FIG. 3, the shock absorption pedal with adjustable resistance disclosed in the present disclosure includes a fixed guide rail 1 might fixed onto a vehicle body by welding or otherwise. A sliding frame 7 matching the fixed guide rail is arranged in the fixed guide rail 1. The sliding frame 7 includes a sliding portion and a support portion. The sliding portion is arranged in the fixed guide rail 1 and can move vertically along the fixed guide rail 1. The support portion is perpendicular to the sliding portion, and is arranged on the side away from the fixed guide rail 1. A support plate 13 is fixedly connected above the support portion by bolts or otherwise. The support plate 13 can move vertically along the fixed guide rail 1 with the sliding frame 7.

Two sliding rollers 9 are arranged at one end of each of a left side and right side of the sliding portion close to the fixed guide rail 1. The sliding roller 9 is connected to the sliding portion through a pin roll. The sliding rollers 9 are arranged in the fixed guide rail 1. The sliding portion moves in the fixed guide rail 1 through the rotation of the sliding rollers 9. The sliding portion is connected to the fixed guide rail 1 through the sliding rollers 9. A friction type between the sliding portion and the fixed guide rail 1 is changed from sliding friction to rolling friction, thereby reducing the internal resistance of the shock absorption pedal of the present disclosure, and improving the shock absorption effect.

Two positioning rollers 2 are arranged on each of two side edges of the fixed guide rail 1. The positioning roller 2 is connected to the fixed guide rail 1 through a roller spindle 3. The direction of the roller shaft 3 is perpendicular to a plane where the fixed guide rail 1 is located, that is, the rotation plane of the positioning roller 2 is parallel to the fixed guide rail 1. When the sliding portion slides in the fixed guide rail 1, the positioning rollers 2 contact a side wall of the sliding portion, which not only limits the lateral movement of the sliding portion, but also reduces a friction force between the sliding portion and the fixed guide rail 1 as much as possible in manner of rolling friction, thereby improving the shock absorption effect.

A baffle is arranged at a top of fixed guide rail 1. A regulating bolt 17 in the vertical direction is arranged on the baffle. One end of the regulating bolt 17 is located outside the fixed guide rail 1 and is connected to a regulating handle 16. A handle fixing block 15 is arranged on the regulating handle 16. The handle fixing block 15 is detachably connected to the baffle of fixed guide rail 1. Another end of the regulating bolt 17 is located inside the fixed guide rail 1 and is connected to a spring regulating block 5. The spring regulating block 5 is connected to a shock absorption spring 6. One end of the shock absorption spring 6 away from the spring regulating block 5 is connected to a spring fixing block 10 fixed onto the sliding frame 7. The vehicle body can shock to drive the fixed guide rail 1 to displace vertically. Due to inertia, the sliding frame 7 and the support plate 13 connected to the sliding frame 7 will not immediately displace, and the shock absorption spring 6 is stretched or compressed, thereby achieving the shock absorption and buffering effect. When it is necessary to regulate the resistance of the shock absorption spring 6, the regulating bolt 17 is regulated to screw in or screw out, and the spring regulating block 5 falls or rises accordingly. Since another end of the shock absorption spring 6 is fixed onto the spring fixing block 10 on the sliding frame 7, the shock absorption spring 6 will be shortened or elongated with the fall or rise of the spring regulating block 5, thereby adjusting the resistance of the shock absorption spring 6.

One side of the fixed guide rail 1 away from the vehicle body is further equipped with a guard plate 14. The guard plate 14 and the fixed guide rail 1 surrounds the sliding portion. A positioning indicator block 4 is arranged on the spring regulating block 5. The guard plate 14 is further provided with a through hole in a corresponding position of the positioning indicator block 4. The position of the limit indicator block 4 can be observed through the through hole, thereby obtaining the position of the spring regulating block 5. An edge of the through hole is further provided with scales, and precise adjustment of the resistance of the shock absorption spring 6 can be realized through the scale.

A bottom of the sliding frame 7 is further connected to one end of a damper 8. Another end of the damper 8 is fixedly connected to the guard plate 14. A rebound speed is controlled by the damper 8, further enhancing the shock absorption effect.

A lower part of the support portion is further equipped with a support base 12 fixedly connected to the vehicle body by welding or otherwise. The support base 12 and the support portion are arranged in parallel at a preset distance. A first shock absorption pad 11 is fixed to the support base 12 through bolts or otherwise. When the support portion is at a lowest point of the sliding stroke, the first shock absorption pad 11 plays a limiting role on the support portion, and further achieves the shock absorption effect. A second shock absorption pad 18 is also fixed to a bottom of the baffle through bolts or otherwise. When the sliding portion is at a highest point of the sliding stroke, the second shock absorption pad 18 plays a limiting role on the sliding portion, and further achieves the shock absorption effect.

It should be noted that the sliding portion further includes a groove. The groove can accommodate the above-mentioned damper 8 and shock absorption spring 6. When the sliding portion slides in the fixed guide rail 1, the groove can allow the relative displacement of the regulating bolt 17 and the spring regulating block 5 in the groove.

In other embodiments of the present disclosure, a combination of the regulating bolt 17, the regulating handle 16, and the handle fixing block 15 may also be other forms of existing displacement regulating mechanisms, such as a combination of a hydraulic rod or a gear and a rack. As long as the relative position of the spring regulating block 5 in the fixed guide rail 1 can be regulated, the technical effect of the present disclosure can be achieved. For example, since the length of the spring can be controlled by controlling the displacement regulating mechanism by a first end located outside the fixed guide rail, this device does not need to be dismantled in the regulating process, which is very convenient.

In other embodiments of the present disclosure, the positioning rollers 2 and the sliding rollers 9 can also be installed in different positions. For example, the positioning rollers 2 are installed on the left side and right side of the sliding portion, and multiple sliding rollers 9 arranged in parallel are installed at a bottom of the groove of the fixed guide rail 1. As long as the rollers are arranged between the sliding portion and the fixed guide rail 1, the positioning rollers 2 are arranged between the left side and right side of the sliding portion and the fixed guide rail 1, and the sliding rollers 9 are arranged between the sliding portion and the bottom of the groove of the fixed guide rail 1, the technical effect of the present disclosure can be achieved.

Certain embodiments of the present disclosure are described in detail above with reference to the accompanying drawings, but the present disclosure is not limited thereto. Various simple variations, including the combination of the technical features in any suitable manner, may be made to the technical solutions of the present disclosure within the scope of the technical concept of the present disclosure. To avoid unnecessary repetitions, various possible combination manners are not described in the present disclosure. However, such simple variations and combinations shall also be considered as the contents disclosed by the present disclosure and shall fall within the protection scope of the present disclosure.

It should be noted that the embodiments are not limited in their application or use to the details of construction and arrangement of parts and steps illustrated in the drawings and description. Features of the illustrative embodiments, constructions, and variants may be implemented or incorporated in other embodiments, constructions, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

Having described the invention in detail and by reference to preferred embodiments thereof, it will be apparent that modifications and variations are possible without departing from the scope of the invention which is defined in the appended claims.

### REFERENCE NUMERALS

Positioning roller

| | | | |
|---|---|---|---|
| 1. | Fixed guide rail | 2. | Positioning roller |
| 3. | Roller shaft | 4. | Positioning indicator block |
| 5. | Spring regulating block | 6. | Shock absorption spring |
| 7. | Sliding frame | 8. | Damper |
| 9. | Sliding roller | 10. | Spring fixing block |
| 11. | First shock absorption pad | 12. | Support base |
| 13. | Support plate | 14. | Guard plate |
| 15. | Handle fixing block | 16. | Regulating handle |
| 17. | Regulating bolt | 18. | Second shock absorption pad |
| 101. | Support base | 102. | Driver pedal |
| 103. | Shock absorption spring | 104. | Guide rail |
| 105. | Regulating screw | 106. | Sliding frame |

What is claimed is:

1. A shock absorption pedal with adjustable resistance, comprising:
a fixed guide rail, fixedly connected to a vehicle body;
a sliding frame, arranged in a groove of the fixed guide rail, and movable vertically along the fixed guide rail; and
a support plate, fixedly connected to the sliding frame,
a displacement regulating mechanism being arranged on the fixed guide rail; one end of the displacement regulating mechanism being arranged outside the groove of the fixed guide rail, and another end of the displacement regulating mechanism being connected to one end of a shock absorption spring; another end of the shock absorption spring being fixedly connected to the sliding frame; and a position of the sliding frame being regulable by the displacement regulating mechanism, to adjust a length of the shock absorption spring.

2. The shock absorption pedal with adjustable resistance according to claim 1, wherein a baffle is arranged at a top of the fixed guide rail; the displacement regulating mechanism comprises a regulating screw and a spring regulating block; the regulating screw penetrates the baffle, with one end located outside the groove of the fixed guide rail, and another end located inside the fixed guide rail and connected to the spring regulating block; and the spring regulating block is connected to one end of the shock absorption spring.

3. The shock absorption pedal with adjustable resistance according to claim 2, wherein one end of the regulating screw located outside the groove of the fixed guide rail is connected to a regulating handle, and the regulating screw is controlled by the regulating handle to screw in or screw out.

4. The shock absorption pedal with adjustable resistance according to claim 2, wherein a guard plate is arranged at one side of the fixed guide rail away from the vehicle body; the guard plate and the fixed guide rail define a channel; the sliding frame is movable vertically in the channel; the guard plate is further provided with a through hole in a corresponding position of the motion trajectory of the sliding frame; and the position of the sliding frame can be observed through the through hole.

5. The shock absorption pedal with adjustable resistance according to claim 4, wherein the guard plate is provided with scales on an edge of the through hole.

6. The shock absorption pedal with adjustable resistance according to claim 1, wherein the sliding frame is connected to the fixed guide rail by rollers, and a rotation direction of the roller is parallel to a relative motion direction of the sliding frame and the fixed guide rail; and the sliding frame achieves relative movement with the fixed guide rail by the rollers.

7. The shock absorption pedal with adjustable resistance according to claim 6, wherein the sliding frame is connected to a side wall of the groove of the fixed guide rail by the rollers.

8. The shock absorption pedal with adjustable resistance according to claim 6, wherein the sliding frame is connected to a bottom wall of the groove of the fixed guide rail by the rollers.

9. The shock absorption pedal with adjustable resistance according to claim 1, wherein the sliding frame and the fixed guide rail are further connected to each other by a damper, and a movement direction of the damper is consistent with that of the shock absorption spring.

10. The shock absorption pedal with adjustable resistance according to claim 1, wherein a shock absorption pad fixedly connected to the vehicle body is arranged at a highest point and/or lowest point of stroke of the support plate.
